(19) United States
(12) Patent Application Publication
(10) Pub. No.: US 2024/0348853 A1
(43) Pub. Date: Oct. 17, 2024

(54) INTERACTIVE HLS STREAM

(71) Applicant: Amagi Corporation, Dover, DE (US)

(72) Inventors: Baskar Subramanian, Bangalore (IN); Siva Natarajan, La Cañada Flintridge, CA (US); Rajiv Kumar, Gurugram (IN); Sahil Malik, Gurugram (IN)

(73) Assignee: Amagi Corporation, Dover, DE (US)

(21) Appl. No.: 18/634,045

(22) Filed: Apr. 12, 2024

Related U.S. Application Data
(60) Provisional application No. 63/496,155, filed on Apr. 14, 2023.

(51) Int. Cl. H04N 21/262; H04N 21/84; H04N 21/854

(52) U.S. Cl. CPC H04N 21/26258; H04N 21/84; H04N 21/854

(57) ABSTRACT

A system and method to enable viewer interaction in HLS streaming comprising (a) a platform (b) a platform backend, (c) a Video On Demand (VOD) service (d) a HLS tag generator (e) a HLS processor (f) an EPG service that stores and provides channel level program information, (g) a playout service and (h) a meta store which is a library of all the content and channel level information. A system and method to enable viewer interaction in HLS streaming wherein viewers commands can be executed and feedback recorded from the video player itself via the HLS stream.

### FIELD OF THE INVENTION

This invention describes a system and method to enable viewer interaction in HLS streaming wherein viewers commands can be executed and feedback recorded from the video player itself via the HLS stream.

### BACKGROUND AND PRIOR ART

With the increased adoption of connected television and other connected devices viewers are consuming more and more content over the internet. While the traditional satellite television and other methods have capabilities only for one way communication where video stream and other content are delivered to the television screen, the internet as a medium can have two-way interaction where a user can both give command and feedback which can be executed or recorded respectively.

This can completely change how a viewer consumes content on his/her screen. He can interact with what is being played, make choices to go to various embedded options like going to other episodes of the program being streamed, start to play from beginning, scan QR codes etc.

In the current system, i) In a linear channel, there is no way a user can interact with the stream other than deciding whether to play the stream or not. ii) Current HLS stream has no information about other content that the user may be interested in. iii) Current HLS stream has no capability to record feedback from the viewer on whether the viewer liked the content or not.

U.S. Ser. No. 11/073,969B2 discloses ‘Multiple-mode system and method for providing user selectable video content’ to the method of providing audiovisual content to a client device configured to be coupled to a display. The method detects a selection of a graphical element corresponding to a video content item.

WO2017123474A1 discloses ‘System and method for operating a video player displaying trick play videos’ receiving a user selection of a slow-motion play mode, in response to the user selection.

The key problems with the above approaches are that the controls are preprogrammed on the video player. The above methods do not provide dynamic interactive controls on the video player based on who the viewer is, when they started to view the program, what content they are watching etc.

### BRIEF DESCRIPTION OF THE DRAWINGS

FIG. 1 End to End Flow of channel delivery in FAST ecosystem.

FIG. 2 Detailed Architecture of interactive HLS system.

FIG. 3 interactive HLS system flow diagram.

### DETAILED DESCRIPTION OF PREFERRED EMBODIMENTS

We disclose a system and method for providing the viewer with an interactive clickable button to the viewers on the frontend player using custom tags inserted in the HLS manifest so that the viewer can perform various kind of actions such as playing the program from beginning in a linear channel, binge watch different episodes of a program that is scheduled on a linear channel, get contextual information about a program, give feedback on whether he likes a program or not. All these can be done by the clicking buttons that are rendered by the frontend player which are powered by tags present in the HLS manifest.

Our invention make use of the following listed services

Platform Frontend: Platform frontend is the software application which is used by the user to view the channel on various devices such as Android TV, Smart phone, Web Browser, Fire TV devices etc. It is the application where the viewer sees all the list of available channels, selects and plays the channel the viewer likes. The Platform frontend is a software application mobile app/TV App etc. which is used to play the content. Eg: Roku, Hotstar etc.

Platform Backend: Platform backend is the backend system which interacts with the Platform Frontend thus providing necessary inputs to be rendered by the Platform frontend. It also collects viewership data like a viewer is watching which program on which channel for how much time etc from the Platform Frontend. The services running in the background to which platform frontend interacts with to keep it functioning also gives the data necessary for running of PLATFORM frontend, and stores the data coming from platform frontend like viewership data, likes and dislikes etc.

VOD Service VOD service or Video on demand service is the streaming service that allows viewers to access and watch video content on-demand. This comprises a massive library of movies and TV shows. Instead of having to wait for a specific time when a show or movie airs on TV, with VOD, the users simply pick what they want to watch from a menu, press play and start viewing immediately.

Tag generator: Tag generator takes information about the scheduled programs from the EPG service, fetches metadata information about the scheduled program and related programs from the metastore and creates a time sequence of custom tags as per requirement. An example of metadata is below. Based on the schedule and metadata information, the TAG generator decides on the custom tags (time sorted) that will be inserted in the ongoing HLS Stream through the duration of the program. We describe some sample metadata fields below.

{
“Channel”:
“Platform”:
“programId”:
“contentType”:
“Title”:
“Description”:
“Language”:
“Genre”:
“Rating”:
“Actor”:
“Director”:
“Producer”:
“Writer”:
“ReleaseDate”:
“AirDate”:
“TotalDuration”:
″Images″
}

The different tags which will be read by the front end player to display various actions/buttons on the app dynamically, instead of preprogramming all of them ahead.

HLS processor: HLS processor gets time sequence of custom tags from the tag generator and inserts these custom tags into the raw manifest, which is a HLS stream received from the playout service. It returns the updated manifest to the Playout service with custom tags inserted. The HLS Processor receives the custom tags from Tag Generator Service and inserts these in the ongoing HLS stream (raw manifest) in real-time.

EPG Service: EPG Service stores and provides channel level program information to be consumed by the Platform backend. In television broadcasting, an electronic program guide (EPG) is an application that provides users with information about current and scheduled programs on a wide range of television channels.

Playout Service: A cloud playout system may be involved for the required content to create a linear viewing experience for the consumers. This Platform or service is responsible for managing the delivery of streaming content to viewers. Playout services play a crucial role in the operation of FAST platforms by ensuring that content is reliably delivered to viewers across various devices.

Metastore: Metastore is a library of all the content and channel level information. This is a Database or repository that stores metadata associated with the streaming content available on the platform. Metadata includes descriptive information about the content, such as titles, descriptions, genres, actors, directors, release dates, ratings, and more. The Metastore serves as a centralized database that allows the platform to efficiently organize, manage, and retrieve information about its content library.

Ingestion is a process of acquiring, preparing, and incorporating video content into the platform's content library.

Graphics—In linear TV, graphic overlays are visual elements that are superimposed onto the screen during the broadcast of television content. These overlays serve various purposes and can include: Channel Logo, Program Information, Ticker (Some channels use a ticker along the bottom or top of the screen to display news headlines, sports scores, stock updates, or other real-time information.) etc.

Ads Insertion—In the context of Free Ad-supported Streaming Television (FAST), ad insertion refers to the process of dynamically inserting advertisements into the streaming content as it is being viewed by the audience. FAST platforms typically offer free streaming content supported by advertisements, similar to traditional television.

Scheduler/Planner: This tool is responsible for organizing and managing the programming lineup, ensuring that content is delivered to viewers in a structured and organized manner.

Ingestion: Process of acquiring, preparing, and incorporating video content into the platform's content library.

Tag time Signal of sequence of tags based on use cases and information from metastore.

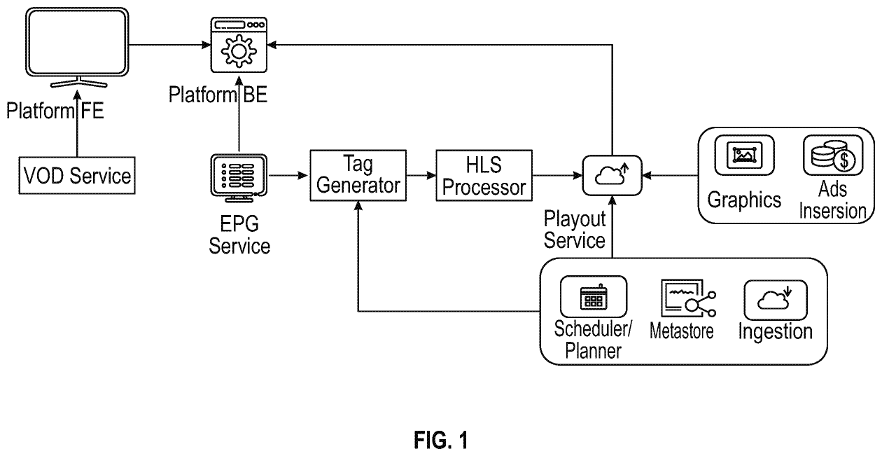

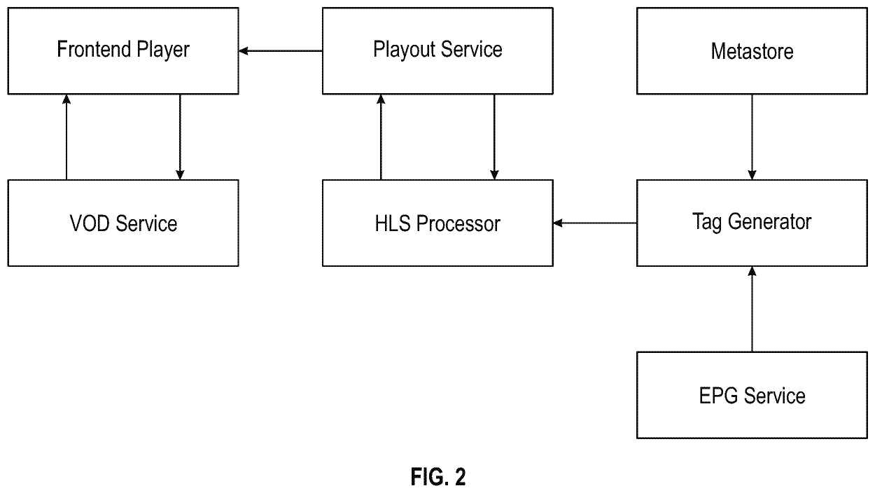

FIG. 1. illustrates an end to end system to acquire and deliver content for a Free Ad Supported Television from a content provider to a Platform so that it can be consumed by a viewer. There are various steps involved such as content ingestion, scheduling/planning of a channel, overlaying graphics, ads insertion, EPG creation/delivery, Playout etc. All the processes eventually lead to the platform frontend rendering a viewer experience which includes an EPG that gives information to the viewer regarding which program will be streamed when and also information about the program itself via textual and graphical user interfaces. When a viewer clicks on to the EPG it results in a playback of the video stream on the platform side. The final delivery of content is done by the video player which is part of the platform frontend. Once the user has selected which channel he wants to watch, there is no further action he can take. With an interactive HLS system as described in FIG. 2, we disclose a system and method which will allow users to play the program from beginning, binge watch other episodes, watch other contextual videos, give feedback on the video etc.

The system of the present invention enable viewer interaction in HTTP Live Streaming (HLS) comprising: (a) A platform frontend which is used by the user to view the channel on various devices and allows the viewer to see a list of available channels, selects and play the channel the viewer likes; (b) A platform backend which interacts with the Platform Frontend thus providing necessary inputs to be rendered by the Platform frontend; (c) A Video On Demand (VOD) service which is a streaming service that allows viewers to access and watch video content on-demand; (d) A HLS tag generator that takes information about the scheduled programs from the EPG service, fetches metadata information about the scheduled program and related programs from the metastore and creates a time sequence of custom tags as per requirement; € A HLS processor that gets time sequence of custom tags from the tag generator and inserts these custom tags into the raw manifest that it fetches from the playout service; (f) An EPG service that stores and provides channel level program information; (g) A playout service which is a cloud playout system may be involved for the required content to create a linear viewing experience for the consumers; and (h) A metastore which is a library of all the content and channel level information.

The system of the present invention uses the VOD information in the tags to allow the player to fetch the embedded VOD content from the VOD service, collects viewership from the Platform Frontend, and allows the user to view the channel on various devices including Android TV, Smart phone, Web Browser and Fire TV devices.

The system of the present invention further (a) Gets information from the EPG Service that says which program is scheduled at what point of time; (b) Gives details on the start time and identity of the program; (c) Gets all the other information like the other associated VOD assets to the scheduled program; (d) Creates a series of tags which contain information about VOD assets which the user may like to play; and € ends this series of custom tags to the HLS processor and further includes the ability for same Custom tag insertion in HLS manifest including the insertion of interactive elements such as (a) QR Codes; (b) Polls; (c) Votes; (d) Likes; € Dislikes; and (f) Favorite buttons.

FIG. 2. illustrates the components which will create an interactive experience via HLS tags. The HLS Tag generator gets information from the EPG that says which program is scheduled at what point of time. It also gives details on the start time and identity of the program. The HLS tag generator then gets all the other information like the other associated VOD assets to the scheduled program, other useful information like cast, ratings etc. Once it has both the information, it creates a series of tags which contain information about VOD assets which the user may like to play. It sends this series of custom tags to the HLS processor. HLS processor inserts this information into the raw manifest that it gets from playout service and returns an updated manifest. Updated manifest is then used for playout, the player understands, interprets the tags and renders the required buttons dynamically. When a user clicks the button, the VOD information in the tags allows the player to fetch the embedded VOD content from the VOD service.

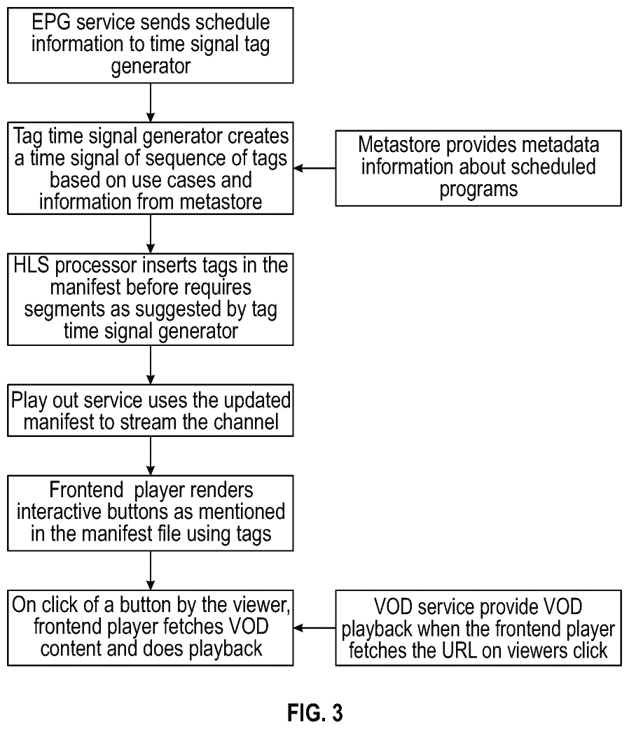

FIG. 3 illustrates the flow, how the system works as explained in the previous section. A computer-implemented method enables viewer interaction in HLS streaming comprising the steps of (a) Sending schedule information from the EPG service to the time signal Tag Generator; (b) The tag-time signal generator creating a time signal comprised of a sequence of tags based on information from the metastore; (c) The HLS processor inserting tags in the manifest before required segments based on suggestions from the tag time signal generator; (d) A playout service using the updated manifest to stream the channel; €A frontend player rendering interactive buttons as mentioned in the manifest file using tags; (f) Upon a viewer clicking a button, a front end player fetching VOD content and playing back the same; and (g) A VOD service providing VOD playback when the frontend player fetches the requisite content based on the user's click. This method includes the ability for same Custom tag insertion in HLS manifest including the insertion of interactive elements such as: (a) QR Codes; (b) Polls; (c) Votes; (d) Likes; €Dislikes; and (f) Favourite buttons.

Our invention also discloses a non-transitory, machine-readable storage medium having stored thereon a computer program to enable viewer interaction in HTTP Live Streaming (HLS), the computer program comprising a set of instructions for causing a machine to perform the steps of the method disclosed in FIG. 3.

The present invention further discloses a scalable computer program product, the computer program product to enable viewer interaction in HTTP Live Streaming (HLS) that adheres to the system and method disclosed above

What is claimed is:

1. A system to enable viewer interaction in HTTP Live Streaming (HLS) comprising:
a) a platform frontend which is used by the user to view the channel on various devices and allows the viewer to see a list of available channels, selects and play the channel the viewer likes;
b) a platform backend which interacts with the Platform Frontend thus providing necessary inputs to be rendered by the Platform frontend;
c) a Video On Demand (VOD) service which is a streaming service that allows viewers to access and watch video content on-demand;
d) a HLS tag generator that takes information about the scheduled programs from the EPG service, fetches metadata information about the scheduled program and related programs from the metastore and creates a time sequence of custom tags as per requirement;
e) a HLS processor that gets time sequence of custom tags from the tag generator and inserts these custom tags into the raw manifest that it fetches from the playout service;
f) an EPG service that stores and provides channel level program information;
g) a playout service which is a cloud playout system may be involved for the required content to create a linear viewing experience for the consumers; and
h) a metastore which is a library of all the content and channel level information.

2. The system of claim 1 wherein when the user clicks the button, the VOD information in the tags allows the player to fetch the embedded VOD content from the VOD service.

3. The system of claim 1 wherein the platform backend collects viewership from the Platform Frontend.

4. The system of claim 1 wherein the platform frontend is used by the user to view the channel on various devices including Android TV, Smart phone, Web Browser and Fire TV devices.

5. The system of claim 1 wherein the HLS tag generator further:
a) gets information from the EPG Service that says which program is scheduled at what point of time;
b) gives details on the start time and identity of the program;
c) gets all the other information like the other associated VOD assets to the scheduled program;
d) creates a series of tags which contain information about VOD assets which the user may like to play; and
e) sends this series of custom tags to the HLS processor.

6. The system of claim 1 including the ability for same Custom tag insertion in HLS manifest including the insertion of interactive elements such as:
a) QR Codes;
b) polls;
c) votes;
d) likes;
e) dislikes; and
f) favorite buttons.

7. A computer-implemented method to enable viewer interaction in HLS streaming comprising the steps of:
a) sending schedule information from the EPG service to the time signal Tag Generator;
b) the tag-time signal generator creating a time signal comprised of a sequence of tags based on information from the metastore;
c) the HLS processor inserting tags in the manifest before required segments based on suggestions from the tag time signal generator;
d) a playout service using the updated manifest to stream the channel;
e) a frontend player rendering interactive buttons as mentioned in the manifest file using tags;
f) upon a viewer clicking a button, a front end player fetching VOD content and playing back the same; and
g) a VOD service providing VOD playback when the frontend player fetches the requisite content based on the user's click.

8. The computer-implemented method of claim 7 including the ability for same Custom tag insertion in HLS manifest including the insertion of interactive elements such as:
a) QR Codes;
b) polls;
c) votes;
d) likes;
e) dislikes; and
f) favourite buttons.

9. A non-transitory, machine-readable storage medium having stored thereon a computer program to enable viewer interaction in HTTP Live Streaming (HLS), the computer program comprising a set of instructions for causing a machine to perform the steps of:
a) sending schedule information from the EPG service to the time signal Tag Generator;
b) the tag-time signal generator creating a time signal comprised of a sequence of tags based on information from the metastore;
c) the HLS processor inserting tags in the manifest before required segments based on suggestions from the tag time signal generator;
d) a playout service using the updated manifest to stream the channel;
e) a frontend player rendering interactive buttons as mentioned in the manifest file using tags;
f) upon a viewer clicking a button, a front end player fetching VOD content and playing back the same; and
g) a VOD service providing VOD playback when the frontend player fetches the requisite content based on the user's click.

10. The non-transitory, machine-readable storage medium having stored thereon a computer of claim 9 including the ability for same Custom tag insertion in HLS manifest including the insertion of interactive elements such as:
a) QR Codes;
b) polls;
c) votes;
d) likes;
e) dislikes; and
f) favourite buttons.

11. A scalable computer program product, the computer program product to enable viewer interaction in HTTP Live Streaming (HLS) comprising:
a) a platform frontend which is used by the user to view the channel on various devices and allows the viewer to see a list of available channels, selects and play the channel the viewer likes;
b) a platform backend which interacts with the Platform Frontend thus providing necessary inputs to be rendered by the Platform frontend;
c) a Video On Demand (VOD) service which is a streaming service that allows viewers to access and watch video content on-demand;
d) a HLS tag generator that takes information about the scheduled programs from the EPG service, fetches metadata information about the scheduled program and related programs from the metastore and creates a time sequence of custom tags as per requirement;
e) a HLS processor that gets time sequence of custom tags from the tag generator and inserts these custom tags into the raw manifest that it fetches from the playout service;
f) an EPG service that stores and provides channel level program information;
g) a playout service which is a cloud playout system may be involved for the required content to create a linear viewing experience for the consumers; and
h) a metastore which is a library of all the content and channel level information.

12. The scalable computer program product of claim 11 comprising the steps of:
a) sending schedule information from the EPG service to the time signal Tag Generator;
b) the tag-time signal generator creating a time signal comprised of a sequence of tags based on information from the metastore;
c) the HLS processor inserting tags in the manifest before required segments based on suggestions from the tag time signal generator;
d) a playout service using the updated manifest to stream the channel;
e) a frontend player rendering interactive buttons as mentioned in the manifest file using tags;
f) upon a viewer clicking a button, a front end player fetching VOD content and playing back the same; and
g) a VOD service providing VOD playback when the frontend player fetches the requisite content based on the user's click.

13. The scalable computer program product of claim 11 including the ability for same Custom tag insertion in HLS manifest including the insertion of interactive elements such as:
a) QR Codes;
b) polls;
c) votes;
d) likes;
e) dislikes; and
f) favourite buttons.
